(19) United States
(12) Patent Application Publication
(10) Pub. No.: US 2025/0054110 A1
(43) Pub. Date: Feb. 13, 2025

(54) IMAGE PROCESSING DEVICE, IMAGE PROCESSING METHOD, AND RECORDING MEDIUM

(71) Applicant: SONY GROUP CORPORATION, TOKYO (JP)

(72) Inventor: KEISUKE CHIDA, TOKYO (JP)

(21) Appl. No.: 18/723,603

(22) PCT Filed: Dec. 20, 2022
(86) PCT No.: PCT/JP2022/046797

§ 371 Date: Jun. 24, 2024

(30) Foreign Application Priority Data
Jan. 4, 2022 (JP) 2022-000185

(51) Int. Cl. G06T 5/60; G06T 5/50; G06T 7/00

(52) U.S. Cl. CPC G06T 5/60; G06T 5/50; G06T 7/0002; G06T 2207/20081; G06T 2207/30168

(57) ABSTRACT

The present technology relates to an image processing device, an image processing method, and a recording medium capable of improving an image quality of an input image of which the degradation process is unknown. An image processing device of the present technology includes a degradation conversion unit that performs degradation processing including mutually different degradation processes on a second image different from an input first image to generate a plurality of degraded images; a comparison unit that compares the first image with each of the plurality of degraded images; and a selection unit that selects, based on a result of comparison by the comparison unit, a parameter to improve the image quality of the first image from among parameters associated with the degradation processes of the plurality of degraded images. The present technology can be applied to, for example, an image processing device that performs super-resolution processing.

### TECHNICAL FIELD

The present technology relates to an image processing device, an image processing method, and a recording medium, and particularly relates to an image processing device, an image processing method, and a recording medium capable of improving the image quality of an input image of which the degradation process is unknown.

### BACKGROUND ART

There is a technology to improve the image quality of an input image by using a converter that has learned an optimal process for restoring an input image of which the degradation process is unknown.

For example, NPL 1 describes a technology to acquire an image quality improvement converter by learning processing of, by using a degradation converter that has learned the characteristics of the degradation process of an input image, converting a high-quality image into a degraded image with a degradation process similar to that of the input image, and converting the degraded image into the original high quality image. This image quality improvement converter can improve the image quality of an input image.

### CITATION LIST

### Non Patent Literature

NPL 1

Jun-Yan Zhu, Taesung Park, Phillip Isola, Alexei A. Efros, “Unpaired Image-to-Image Translation using Cycle-Consistent Adversarial Networks”, ICCV2017, 24 Aug. 2020

### SUMMARY

### Technical Problem

The technology described in NPL 1 requires a sufficient number of input images to improve the accuracy of learning the characteristics of the degradation process of an input image. Therefore, for example, for a single input image, it is not possible to obtain a degraded image in which the degradation process of that input image is sufficiently reproduced, and the accuracy of the image quality improvement converter is reduced accordingly. Therefore, there is a possibility that the image quality of the input image cannot be improved sufficiently using the image quality improvement converter.

The present technology has been made in view of such circumstances, and makes it possible to improve the image quality of an input image of which the degradation process is unknown.

### Solution to Problem

An image processing device according to one aspect of the present technology includes a degradation conversion unit that performs degradation processing including mutually different degradation processes on a second image different from an input first image to generate a plurality of degraded images; a comparison unit that compares the first image with each of the plurality of degraded images; and a selection unit that selects, based on a result of comparison by the comparison unit, a parameter to improve an image quality of the first image from among parameters associated with the degradation processes of the plurality of degraded images.

An image processing method according to one aspect of the present technology includes, by an image processing device, performing degradation processing including mutually different degradation processes on a second image different from an input first image to generate a plurality of degraded images; comparing the first image with each of the plurality of degraded images; and selecting, based on a result of comparison between the first image and each of the plurality of degraded images, a parameter to improve an image quality of the first image from among parameters associated with the degradation processes of the plurality of degraded images.

A recording medium according to one aspect of the present technology records a program for executing processing of performing degradation processing including mutually different degradation processes on a second image different from an input first image to generate a plurality of degraded images; comparing the first image with each of the plurality of degraded images; and selecting, based on a result of comparison between the first image and each of the plurality of degraded images, a parameter to improve an image quality of the first image from among parameters associated with the degradation processes of the plurality of degraded images.

In one aspect of the present technology, degradation processing including mutually different degradation processes is performed on a second image different from an input first image to generate a plurality of degraded images, the first image is compared with each of the plurality of degraded images, and based on a result of comparison between the first image and each of the plurality of degraded images, a parameter to improve an image quality of the first image is selected from among parameters associated with the degradation processes of the plurality of degraded images.

### BRIEF DESCRIPTION OF DRAWING

FIG. 1 is a block diagram illustrating a configuration example of an image processing device according to a first embodiment of the present technology.

FIG. 2 illustrates an example of information stored in a storage unit.

FIG. 3 is a diagram illustrating an example of information used for database learning.

FIG. 4 is a flowchart illustrating processing performed by an image processing device.

FIG. 5 is a diagram illustrating examples of successful image quality improvement signal processing and when failed image quality improvement signal processing.

FIG. 6 is a diagram illustrating a flow of conventional image quality improvement signal processing.

FIG. 7 is a diagram illustrating a flow of another conventional image quality improvement signal processing.

FIG. 8 is a block diagram illustrating a configuration example of an image processing device according to a second embodiment of the present technology.

FIG. 9 illustrates an example of a database mixing method.

FIG. 10 illustrates another example of a database mixing method.

FIG. 11 illustrates an example of whether or not each type of degradation process is allowed for mixing.

FIG. 12 is a flowchart illustrating processing performed by an image processing device.

FIG. 13 is a block diagram illustrating a configuration example of computer hardware.

### DESCRIPTION OF EMBODIMENTS

Embodiments for implementing the present technology will be described below. The description will be made in the following order.
1. First embodiment (example of selecting databases)
2. Second embodiment (example of mixing databases)
3. Application example

### 1. First Embodiment (Example of Selecting Databases)

### Configuration of Image Processing Device 11

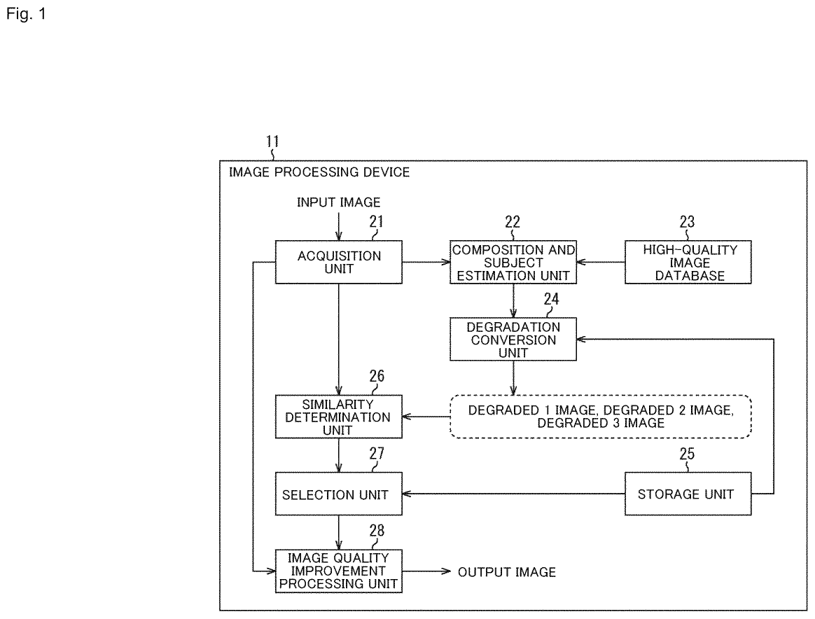

FIG. 1 is a block diagram illustrating a configuration example of an image processing device 11 according to a first embodiment of the present technology.

The image processing device 11 in FIG. 1 is, for example, a device that performs super-resolution processing including degradation processes to improve the image quality of an input image generated.

As illustrated in FIG. 1, the image processing device 11 includes an acquisition unit 21, a composition and subject estimation unit 22, a high-quality image database 23, a degradation conversion unit 24, a storage unit 25, a similarity determination unit 26, a selection unit 27, and an image quality improvement processing unit 28.

The acquisition unit 21 acquires an input image input to the image processing device 11 and supplies the input image to the composition and subject estimation unit 22, the similarity determination unit 26, and the image quality improvement processing unit 28.

The composition and subject estimation unit 22 estimates the subject and composition of the input image supplied from the acquisition unit 21, and acquires a high quality image from the high-quality image database 23 based on the result of estimation. Specifically, the composition and subject estimation unit 22 selects a high-quality image with a subject and composition similar to the subject and composition of the input image from among high-quality images stored in the high-quality image database 23. The composition and subject estimation unit 22 supplies the selected high-quality image to the degradation conversion unit 24.

The high-quality image database 23 stores various types of high-quality images. Each high-quality image is, for example, an image with a higher quality than the input image. The high-quality image database 23 may be deployed on cloud.

The degradation conversion unit 24 performs degradation processing including mutually different degradation processes on the high-quality image supplied from the composition and subject estimation unit 22 to generate a plurality of degraded images. Specifically, the degradation conversion unit 24 acquires all the information indicating the degradation processes stored in the storage unit 25, and performs degradation processing including the degradation processes on the high-quality image.

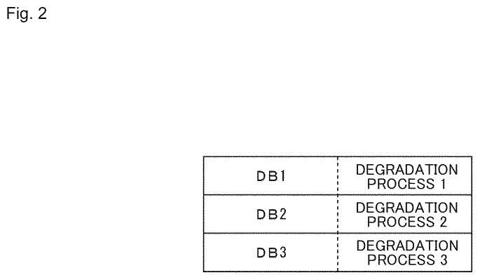

FIG. 2 illustrates an example of information stored in the storage unit 25.

In the storage unit 25, each degradation process is stored in association with a database used to improve the image quality of the input image. For example, network parameters to improve the image quality of the input image are recorded in the database. In the example of FIG. 2, degradation process 1 is associated with database DB1, and degradation process 2 is associated with database DB2. In addition, degradation process 3 is associated with database DB3.

Databases DB1 to DB3 are acquired through learning using teacher images serving as a learning teacher and student images serving as a learning student.

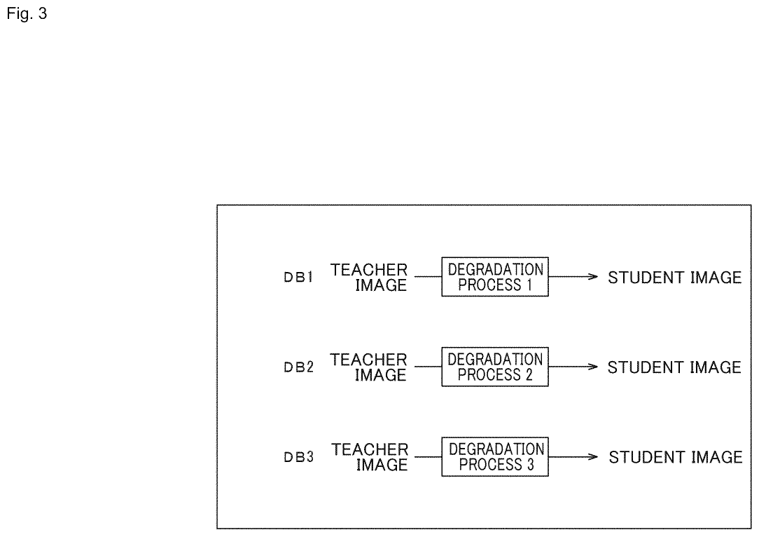

FIG. 3 is a diagram illustrating an example of information used for databases DB1 to DB3 learning.

The learning of database DB1 uses a teacher image and a student image acquired by performing, on the teacher image, degradation processing including degradation process 1 associated with database DB1, as illustrated in the first row of FIG. 3. Degradation process 1 indicates that, for example, an image having an original size of Standard Definition (SD) is enlarged or reduced, and is encoded using an encoding method of Advanced Video Coding (AVC) with a bit rate of 1 Mbps. In this way, the degradation processes associated with one database include degradation processes belonging to various categories.

The learning of database DB2 uses a teacher image and a student image acquired by performing, on the teacher image, degradation processing including degradation process 2 associated with database DB2, as illustrated in the second row of FIG. 3. Degradation process 2 indicates, for example, that an image having an original size of 4K is enlarged or reduced, and is encoded using an encoding method of Joint Photographic Experts Group (JPEG).

The learning of database DB3 uses a teacher image and a student image acquired by performing, on the teacher image, degradation processing including degradation process 3 associated with database DB3, as illustrated in the third row of FIG. 3. Degradation process 3 indicates, for example, that an image having an original size of High Definition (HD) is enlarged or reduced, and is encoded using an encoding method of Moving Picture Experts Group (MPEG) with a bit rate of 12 Mbps.

Returning to FIG. 1, the degradation conversion unit 24 performs degradation processing including degradation processes 1 to 3 described above on the high-quality image to generate a degraded 1 image, a degraded 2 image, and a degraded 3 image. The degradation conversion unit 24 supplies these degraded images to the similarity determination unit 26.

The similarity determination unit 26 functions as a comparison unit that compares the input image supplied from the acquisition unit 21 with each of the degraded 1 image, the degraded 2 image, and the degraded 3 image, which are supplied from the degradation conversion unit 24. Specifically, the similarity determination unit 26 calculates a similarity between the input image and each of the degraded 1 image, the degraded 2 image, and the degraded 3 image, and supplies information indicating the similarity between the input image and each degraded image to the selection unit 27.

The selection unit 27 selects an applicable database to be used to improve the image quality of the input image from among databases DB1 to DB3 stored in the storage unit 25, based on the result of comparison by the similarity determination unit 26. Specifically, the selection unit 27 acquires from the storage unit 25 a database associated with the degradation process of the degraded image with the highest similarity to the input image, and supplies the database to the image quality improvement processing unit 28.

The image quality improvement processing unit 28 performs image quality improvement signal processing on the input image supplied from the acquisition unit 21 by using the database supplied from the selection unit 27 to generate an output image as an output result.

### Operation of Image Processing Device 11

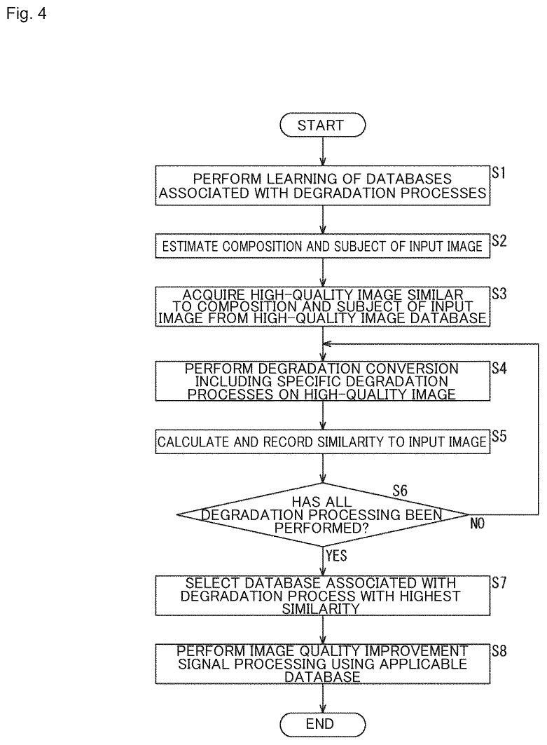

Here, processing performed by the image processing device 11 having the above-described configuration will be described with reference to a flowchart of FIG. 4.

In step S1, the image processing device 11 performs learning of databases associated with mutually different degradation processes. The database acquired as a result of learning is stored in the storage unit 25 in association with the degradation process of the student image used for the database learning. The processing of step S1 only needs to be performed once as a preliminary preparation, and does not need to be performed every time an input image is input.

In step S2, the composition and subject estimation unit 22 estimates a composition and subject of the input image.

In step S3, the composition and subject estimation unit 22 acquires a high-quality image of a composition and subject similar to the composition and subject of the input image from the high-quality image database 23.

In step S4, the degradation conversion unit 24 performs degradation processing including specific degradation processes on the high-quality image acquired by the composition and subject estimation unit 22 to generate a degraded image.

In step S5, the similarity determination unit 26 calculates and records a similarity between the input image and each degraded image.

In step S6, the degradation conversion unit 24 determines whether or not all degradation processing has been performed. For example, when the degradation conversion unit 24 generates degraded images generated including all the degradation processes stored in the storage unit 25, it determines that all degradation processing have been performed.

If it is determined in step S6 that all degradation processing has not been performed, returning to step S4, the subsequent processing is repeated until the similarities between all the degraded images and the input image are calculated.

If it is determined in step S6 that all degradation processing has been performed, the processing proceeds to step S7. In step S7, the selection unit 27 selects, from among the databases stored in the storage unit 25, the database associated with the degradation process of the degraded image with the highest similarity to the input image, as the applicable database.

In step S8, the image quality improvement processing unit 28 performs image quality improvement signal processing on the input image using the applicable database.

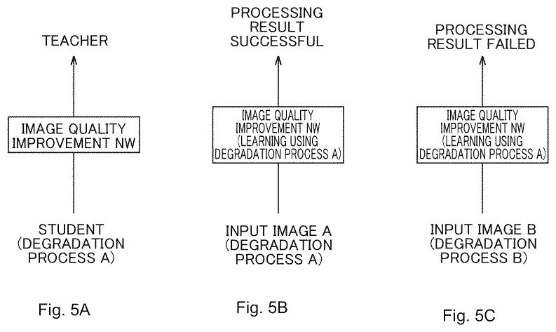

FIG. 5 is a diagram illustrating examples of successful image quality improvement signal processing and when failed image quality improvement signal processing.

As illustrated in A of FIG. 5, it is assumed that image quality improvement network (NW) has been acquired through learning using teacher images and student images generated including degradation process A. As illustrated in B of FIG. 5, when input image A generated including degradation process A is input to image quality improvement NW, the processing result of the image quality improvement signal processing by image quality improvement NW will be successful.

On the other hand, as illustrated in C of FIG. 5, when input image B generated including degradation process B different from degradation process A is input to image quality improvement NW, the processing result of the image quality improvement signal processing by image quality improvement NW will be failed. For example, an image with no sharpness or an overemphasized image is output as the processing result of the image quality improvement signal processing.

When input image A or input image B are input to image quality improvement NW acquired by learning using a mixture of student images and teacher images generated including degradation process A and student images and teacher images generated including degradation process B, the processing result thus obtained indicates that the quality is inferior to the processing result in case B of FIG. 5 is obtained.

As described above, when the degradation process of the student images used for learning matches the degradation process of the input image, a high-quality output image can be obtained, but otherwise image quality improvement NW cannot demonstrate satisfactory performance.

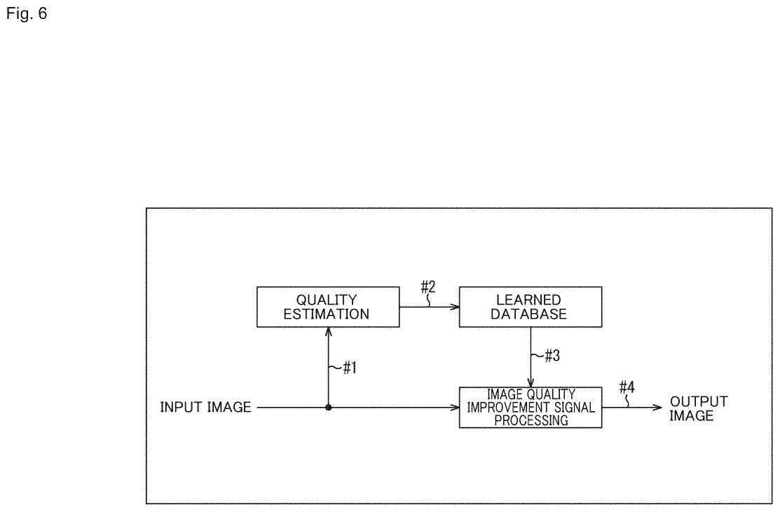

FIG. 6 is a diagram illustrating a flow of conventional image quality improvement signal processing.

In order to match the degradation process of student images and the degradation process of an input image, in conventional image quality improvement signal processing, a degradation process of the input image is estimated as indicated by arrow #1 in FIG. 6, and a learned database associated with the degradation process of the input image is selected as indicated by arrow #2. Thereafter, image quality improvement signal processing is performed using the selected learned database as indicated by arrow #3, and an output image is generated as indicated by arrow #4.

In the conventional image quality improvement signal processing, the types of degradation processes that can be estimated are limited by an estimator. The estimator estimates only a specific degradation process from among degradation processes such as camera blur due to focus or movement, dark area noise, distortion due to compression encoding, enlargement, and reduction, for example, and therefore cannot estimate other degradation processes than the types that can be estimated. For example, the estimator cannot estimate the degradation process of an input image encoded using a new encoding method. For example, for an input image generated including a plurality of degradation processes in combination, the estimator exhibits a reduced accuracy of estimation.

The conventional image quality improvement signal processing may fail to estimate the degradation process, and in that case, the accuracy of the estimator is insufficient to optimally control the processing content to improve the image quality of an input image of which the degradation process is unknown. It is not realistic to prepare an estimator that can estimate countless combinations of degradation processes in order to deal with all degradation processes.

Instead of selecting a database according to a directly estimated degradation process of an input image, the image processing device 11 of the present technology calculates similarities based on comparison between the pixel values of the input image and the degraded images, and selects the database with the highest similarity as the applicable database. Thus, from among the image quality improvement signal processing that can be performed by the image processing device 11, the processing that can obtain the best processing result can be selected. Since the degradation process of the input image is estimated using a method that can be expected to estimate unknown types of degradation processes with a certain degree of accuracy, it may be possible to deal with an input image generated including an unknown type of degradation process.

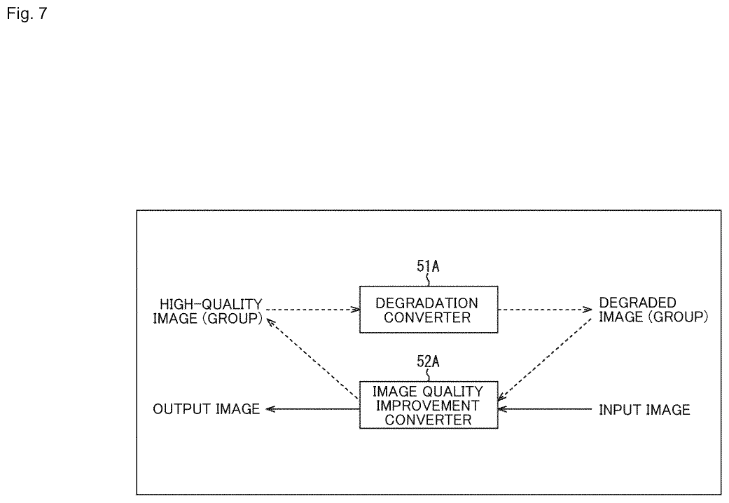

FIG. 7 is a diagram illustrating a flow of another conventional image quality improvement signal processing. In FIG. 7, broken line arrows indicate the flow of learning, and solid line arrows indicate the flow of improving the image quality of an input image.

In the example of FIG. 7, a group of high-quality images different from the input image and a group of degraded images generated including degradation processes similar to those of the input image are prepared in advance. First, a degradation converter 51A learns to convert a group of high-quality images into a group of images generated including degradation processes similar to the degradation processes of the input image. Further, an image quality improvement converter 52A learns to convert a group of degraded images into a group of high-quality images. In the learning of the degradation converter 51A, the parameters for the degradation converter 51A are adjusted so that the degradation processes of the result of conversion by the degradation converter 51A are the same as the degradation processes of the group of degraded images. In the learning of the image quality improvement converter 52A, the parameters for the image quality improvement converter 52A are adjusted so that the image quality of the result of conversion by the image quality improvement converter 52A is the same as the image quality of the group of high-quality images.

Next, the image quality improvement converter 52A learns so that a result of conversion obtained in response to an input of the result of conversion by the degradation converter 51A to the image quality improvement converter 52A is the same as the original group of high-quality images. Further, the degradation converter 51A learns so that a result of conversion obtained in response to an input of the result of conversion by the image quality improvement converter 52A to the degradation converter 51A is the same as the original group of degraded images.

By inputting an input image to the image quality improvement converter 52A acquired through learning, an output image in which the image quality of the input image is improved is generated even if the degradation process(s) of the input image are unknown.

When the image quality of an input image is actually improved, in the learning of the degradation converter 51A, the parameters for the degradation converter 51A may be adjusted without being able to prepare in advance a group of degraded images generated including the degradation processes of the input image so that the degradation processes of the result of conversion by the degradation converter 51A are the same as the degradation processes of the input image. Since a sufficient number of input images is required to improve the accuracy of learning of the degradation converter 51A, for a single input image, the degradation converter 51A exhibits a reduced accuracy of conversion. Therefore, since the current technology cannot sufficiently imitate degraded images, the result of conversion by the degradation converter 51A may not be similar to the group of degraded images or may include unnecessary degradation processes. In addition, it is difficult to determine whether or not the result of conversion by the degradation converter 51A has sufficient accuracy as student images for the image quality improvement converter 52A.

Since a large amount of repeated calculations are required for both the learning of the degradation converter 51A and the learning of the image quality improvement converter 52A, the time and calculation cost required for image quality improvement signal processing is increased. The accuracy of conversion by the image quality improvement converter 52A includes double accuracy degradation: the degradation of the accuracy of learning of the degradation converter 51A and the degradation of the accuracy of learning of the image quality improvement converter 52A itself. Therefore, it is difficult to improve the accuracy of conversion by the image quality improvement converter 52A.

In the image processing device 11 of the present technology, since the degradation processes associated with the respective databases that are selection candidates for the applicable database are known, the accuracy of the student images used for the databases learning is ensured. Therefore, the accuracy of image quality improvement signal processing for an input image generated including degradation processes associated with the respective databases is also increased.

As described above, even if the degradation process of an input image is unknown, the image processing device 11 selects a database that can accurately improve the image quality of the input image, making it possible to improve the image quality of the input image using the database.

### 2. Second Embodiment (Example of Mixing Databases)

### Configuration of Image Processing Device 11

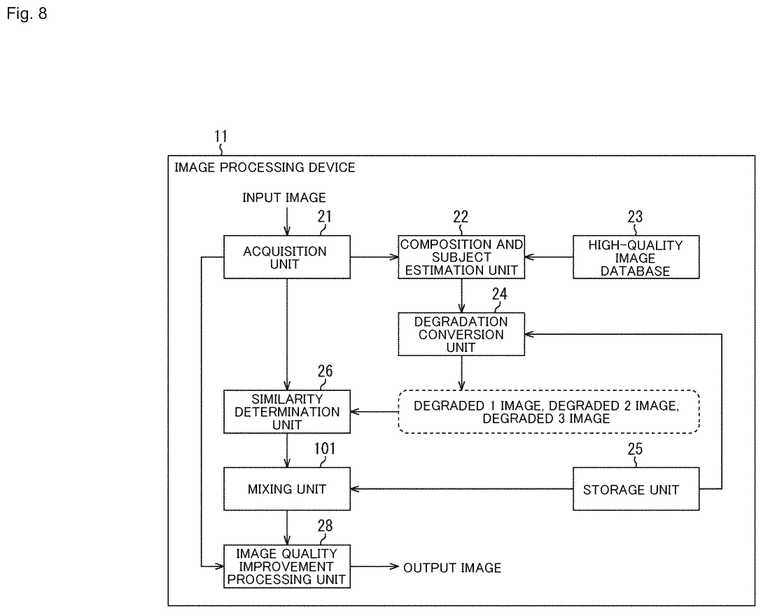

FIG. 8 is a block diagram illustrating a configuration example of an image processing device 11 according to a second embodiment of the present technology. In FIG. 8, the same components as those in FIG. 1 are denoted by the same reference numerals. Redundant description will be appropriately omitted.

The configuration of the image processing device 11 illustrated in FIG. 8 differs from the configuration of the image processing device 11 in FIG. 1 in that a mixing unit 101 is provided instead of the selection unit 27.

The mixing unit 101 selects a plurality of databases to improve the image quality of the input image from among the databases stored in the storage unit 25, based on the result of comparison by the similarity determination unit 26. Specifically, the mixing unit 101 selects a plurality of databases associated with the degradation processes of a predetermined number of top degraded images with the highest similarity to the input image among the degraded images generated by the degradation conversion unit 24.

The mixing unit 101 mixes the selected databases at a mixing ratio according to the similarity to the input image to generate an applicable database used to improve the image quality of the input image. The mixing unit 101 supplies the applicable database to the image quality improvement processing unit 28.

The image quality improvement processing unit 28 performs image quality improvement signal processing on the input image using the applicable database supplied from the mixing unit 101 to generate an output image.

### Mixing Method for Degradation Processes Represented Using Combinations of Three Categories

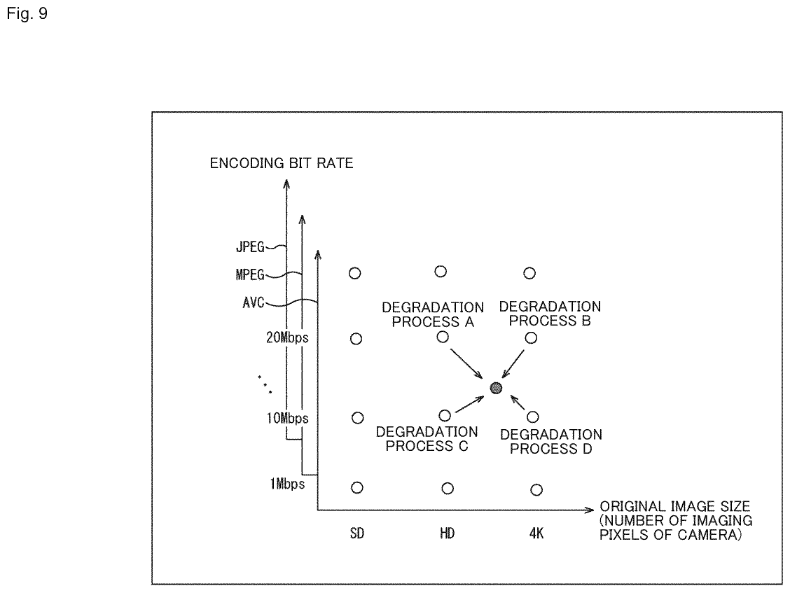

FIG. 9 illustrates an example of a database mixing method.

For example, it is assumed that each degradation process associated with the database is represented by a combination of three categories: original image size, encoding bit rate, and encoding method. In the example of FIG. 9, SD, HD, and 4K are represented as the types of original image sizes, and 1 Mbps, 10 Mbps, and 20 MBps are represented as the types of encoding bit rates. AVC, MPEG, and JPEG are represented as types of encoding methods.

In FIG. 9, points on each plane with two axes of original size and encoding bit rate of the image indicate degradation processes, respectively. Each plane is independent for each type of encoding method, and the mixing unit 101 does not mix databases associated with degradation processes of different types of encoding methods. Among different types of encoding methods, the characteristics of the databases also differ significantly. Therefore, the databases associated with the degradation processes of different types of encoding methods are not suitable for mixing. Thus, each degradation process is classified on an independent plane for each type of encoding method.

First, the mixing unit 101 selects the type of encoding method with the highest similarity. Specifically, the mixing unit 101 calculates an average similarity for each type of encoding method, and selects the type of encoding method with the highest average similarity. For example, the mixing unit 101 selects AVC as the encoding method with the highest similarity.

Next, the mixing unit 101 selects the top four degradation processes with the highest similarity from among the degradation processes of the selected encoding method. In FIG. 9, four degradation processes A to D are selected. For example, degradation process A indicates that an image having an original size of HD is enlarged or reduced and is encoded using an encoding method of AVC with a bit rate of 20 Mbps, and degradation process B indicates that an image having an original size of 4K is enlarged or reduced and is encoded using an encoding method of AVC with a bit rate of 20 Mbps. Degradation process C indicates that an image having an original size of HD is enlarged or reduced and is encoded using an encoding method of AVC with a bit rate of 10 Mbps, and degradation process D indicates that an image having an original size of 4K is enlarged or reduced and is encoded using an encoding method of AVC with a bit rate of 10 Mbps.

Next, the mixing unit 101 weights each of the databases associated with the respective four degradation processes according to the corresponding similarity, and mixes the four databases. The databases associated with respective degradation processes A to D are mixed to generate a database associated with a degradation process of the input image represented by a colored circle in FIG. 9. When the database is expressed using a filter coefficient, a mixDB value, which is a filter coefficient after mixing, is expressed by the following Equation (1).

$$[ Math . 1 ]$$

$$mixDB VALUE = \frac{SIMILARITY A}{\sum ( SIMILARITIES A TO D )} \times DB ( A ) + \frac{SIMILARITY B}{\sum ( SIMILARITIES A TO D )} \times DB ( B ) + \frac{SIMILARITY C}{\sum ( SIMILARITIES A TO D )} \times DB ( C ) + \frac{SIMILARITY D}{\sum ( SIMILARITIES A TO D )} \times DB ( D ) \qquad ( 1 )$$

In Equation (1), similarities A to D indicate similarities between the degraded images generated including respective degradation processes A to D and the input image, and indicate values of 0.0 to 1.0. DB(A) to DB(D) indicate filter coefficients for respective degradation processes A to D.

### Mixing Method for Degradation Processes Represented Using Combinations of Four Categories

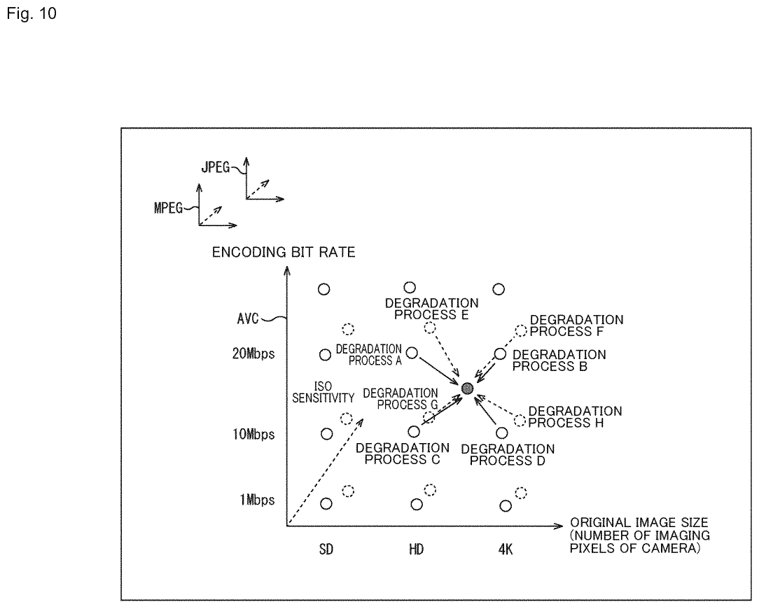

FIG. 10 illustrates another example of a database mixing method.

For example, it is assumed that each degradation process associated with the database is represented by a combination of four categories: original image size, encoding bit rate, encoding method, and ISO sensitivity. In the example of FIG. 10, SD, HD, and 4K are represented as the types of original image sizes, and 1 Mbps, 10 Mbps, and 20 MBps are represented as the types of encoding bit rates. AVC, MPEG, and JPEG are represented as types of encoding methods.

In FIG. 10, points on each space with three axes of original size, encoding bit rate, and ISO sensitivity of the image indicate degradation processes, respectively. Each space is independent for each encoding method, and the mixing unit 101 does not mix databases associated with degradation processes of different types of encoding methods.

First, the mixing unit 101 selects the type of encoding method with the highest similarity. Specifically, the mixing unit 101 calculates an average similarity for each type of encoding method, and selects the type of encoding method with the highest average similarity. For example, the mixing unit 101 selects AVC as the encoding method with the highest similarity.

Next, the mixing unit 101 selects the top eight degradation processes with the highest similarity from among the degradation processes of the selected encoding method. In FIG. 10, eight degradation processes A to H are selected.

Next, the mixing unit 101 weights each of the databases associated with the respective eight degradation processes according to the corresponding similarity, and mixes the eight databases. The databases associated with respective degradation processes A to H are mixed to generate a database associated with a degradation process of the input image represented by a colored circle in FIG. 10. When the database is expressed using a filter coefficient, a mixDB value is expressed by the following Equation (2).

$$[ Math . 2 ]$$

$$mixDB VALUE = \frac{SIMILARITY A}{\sum ( SIMILARITIES A TO H )} \times DB ( A ) + \frac{SIMILARITY B}{\sum ( SIMILARITIES A TO H )} \times DB ( B ) + \frac{SIMILARITY C}{\sum ( SIMILARITIES A TO H )} \times DB ( C ) + \frac{SIMILARITY D}{\sum ( SIMILARITIES A TO H )} \times DB ( D ) + \frac{SIMILARITY E}{\sum ( SIMILARITIES A TO H )} \times DB ( E ) + \frac{SIMILARITY F}{\sum ( SIMILARITIES A TO H )} \times DB ( F ) + \frac{SIMILARITY G}{\sum ( SIMILARITIES A TO H )} \times DB ( G ) + \frac{SIMILARITY H}{\sum ( SIMILARITIES A TO H )} \times DB ( H ) \qquad ( 2 )$$

In Equation (2), similarities A to H indicate similarities between the degraded images generated including respective degradation processes A to H and the input image, and indicate values of 0.0 to 1.0. DB (A) to DB (H) indicate filter coefficients for respective degradation processes A to H.

The applicable database may be selected from among databases generated by mixing the databases associated with the top eight degradation processes with the highest similarity for each encoding method.

### Typical Categories of Degradation Processes

The categories of degradation processes are classified by, for example, imaging conditions and encoding conditions. The category of the imaging conditions includes an original size, an ISO sensitivity, and a frame rate of the image. The category of the encoding conditions includes an encoding method and an encoding bit rate (quality).

For example, the original size of the image is included in a typical category of degradation process because the image size may be changed by trimming or the like in an editing process at a broadcasting station. The encoding method and the encoding bit rate are included in the typical categories of degradation processes because the encoding method differs depending on the camera, broadcasting device, and editing device to use, and the encoding method and encoding bit rate vary depending on the broadcasting route and distribution route for the image. The ISO sensitivity is included in a typical category of degradation process of the input image because the amount of noise contained in the image changes depending on the ISO sensitivity at the time of image capture. The frame rate is included in a typical category of degradation process because the frame rate differs depending on the camera settings at the time of image capture.

Among original sizes, encoding bit rates, encoding methods, ISO sensitivities, and frame rate of the image, categories are set in advance in which databases associated with degradation processes of different types are not allowed for mixing.

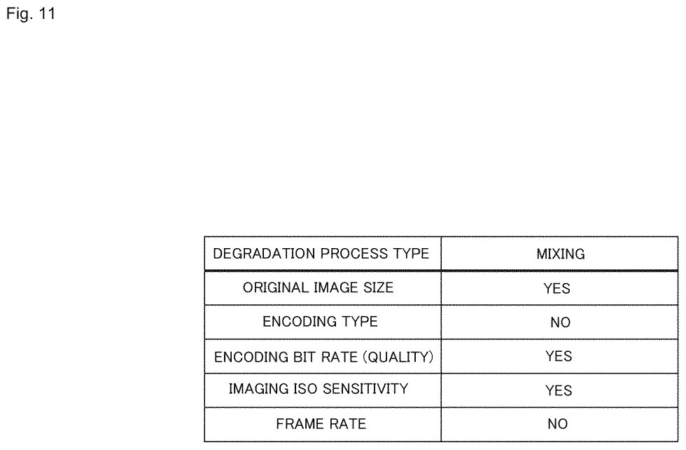

FIG. 11 illustrates an example of whether or not each category of degradation process is allowed for mixing.

In the example in FIG. 11, in mixing databases, the databases for different types of image original sizes, encoding bit rates, and ISO sensitivities are allowed for mixing, and the databases for different types of encoding methods and frame rates are not allowed for mixing.

In this case, the mixing unit 101 does not mix the databases associated with degradation processes of different types of encoding methods, and does not mix the databases associated with degradation processes of different types of frame rates. When there are a plurality of categories that are not allowed for mixing, the mixing unit 101 sequentially selects specific types of degradation processes based on the average similarity for each type of degradation process in each category. For example, the mixing unit 101 calculates an average similarity for each frame rate, and selects the frame rate with the highest average similarity. Thereafter, the mixing unit 101 calculates an average similarity for each encoding method, and selects the encoding method with the highest average similarity.

After selecting specific types of degradation processes from among the categories that are not allowed for mixing, the mixing unit 101 weights each of the databases associated with the respective degradation processes indicated in the combination of categories that are allowed for mixing, according to the corresponding similarity, and calculates a mixDB value. When there are four categories that are allowed for mixing, it is desirable that 16 databases be mixed, but it is not necessary to mix 16 databases.

In the example illustrated in FIG. 11, the databases for different types of encoding systems and frame rates, which vary greatly in database characteristics are not allowed for mixing. However, the types of degradation processes that are not allowed for mixing in mixing databases do not necessarily have to be determined as illustrated in FIG. 11.

### Operation of Image Processing Device 11

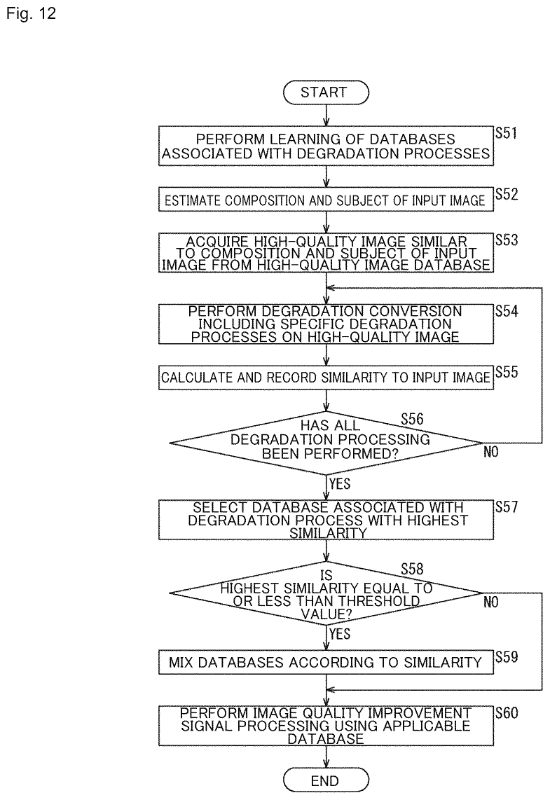

Here, processing performed by the image processing device 11 having the above-described configuration will be described with reference to a flowchart of FIG. 12.

Processing of steps S51 to S56 is the same as processing of steps S1 to S6 of FIG. 4. Degradation conversion is performed on a high-quality image with a composition and subject similar to the composition and subject of the input image to generate a degraded image. Further, a similarity between each degraded image and the input image is calculated and recorded.

In step S57, the mixing unit 101 selects, from among the databases stored in the storage unit 25, the database associated with the degradation process of the degraded image with the highest similarity to the input image.

In step S58, the mixing unit 101 determines whether or not the highest similarity is equal to or less than a threshold value.

If it is determined in step S58 that the highest similarity is equal to or less than the threshold value, the processing proceeds to step S59. In step S59, the mixing unit 101 mixes the databases according to the similarity to generate an applicable database. After the databases have been mixed, the processing proceeds to step S60.

On the other hand, if it is determined in step S58 that the highest similarity exceeds the threshold value, step S59 is skipped, and the mixing unit 101 sets the database associated with the degradation process with the highest similarity as the applicable database. Thereafter, the processing proceeds to step S60.

In step S60, the image quality improvement processing unit 28 performs image quality improvement signal processing on the input image using the applicable database.

Through the above processing, if the image processing device 11 does not have a database suitable for improving the image quality of the input image, the image processing device 11 can generate a database to be used to accurately improve the image quality of the input image by combining the databases that it already has. The image processing device 11 can improve the image quality of the input image using the newly generated database.

### 3. Application Example

The present technology can be applied, for example, to improving the image quality of old video materials. The image processing device 11 can perform image quality improvement signal processing on an image of which the degradation process is unknown, such as old movie and photograph.

The present technology can be applied, for example, to improving the image quality of video that has been subjected to a lot of video editing. The image processing device 11 can perform image quality improvement signal processing on an image for which it is difficult to estimate the degradation process because the image is compressed, encoded, enlarged, or reduced every time it is edited.

The present technology can be applied, for example, to improving the image quality of an image captured by a camera with unknown imaging characteristics.

As described above, the image processing device 11 of the present technology can be used in a video production site where video editing is performed after restoring degradation in the previous process, photo restoration, and a video distribution system that uses a camera used or a video for which the editing process is unknown.

### Computer

The series of processing described above can be executed by hardware or software. When the series of processing is performed by software, a program for the software is embedded in dedicated hardware to be installed from a program recording medium to a computer or a general-purpose personal computer.

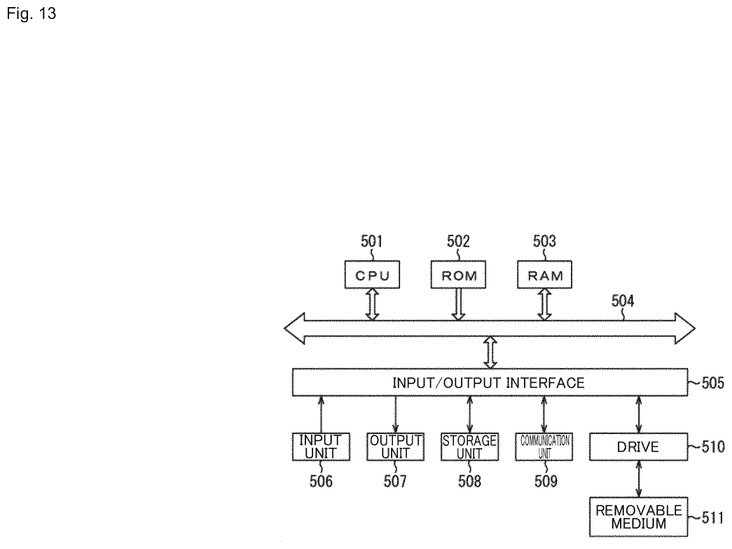

FIG. 13 is a block diagram illustrating an example of a hardware configuration of a computer that executes the series of processes described above according to a program.

A central processing unit (CPU) 501, a read-only memory (ROM) 502, and a random access memory (RAM) 503 are connected to each other via a bus 504.

An input/output interface 505 is additionally connected to the bus 504. An input unit 506 including a keyboard, a mouse, and the like and an output unit 507 including a display, a speaker, and the like are connected to the input/output interface 505. In addition, a storage unit 508 including a hard disk and a non-volatile memory, a communication unit 509 including a network interface, and a drive 510 that drives a removable medium 511 are connected to the input/output interface 505.

In the computer configured as described above, for example, the CPU 501 performs the above-described series of processing by loading a program stored in the storage unit 508 into the RAM 503 via the input/output interface 505 and the bus 504 and executing the program.

The program executed by the CPU 501 is recorded on, for example, the removable medium 511 or is provided via wired or wireless transfer media such as a local area network, the Internet, and a digital broadcast and is installed in the storage unit 508.

The program executed by the computer may be a program that performs a plurality of steps of processing in time series in the order described herein or may be a program that performs a plurality of steps of processing in parallel or at a necessary timing such as when a call is made.

In the present specification, a system means a collection of a plurality of constituent elements (devices, modules (components) or the like) regardless of whether all the constituent elements are located in the same casing. Thus, a plurality of devices housed in separate housings and connected via a network, and one device in which a plurality of modules are housed in one housing are both systems.

The advantageous effects described herein are merely examples and are not limited, and other effects may be obtained.

Embodiments of the present technology are not limited to the above-described embodiments, and various changes can be made without departing from the scope and spirit of the present technology.

For example, the present technology may be configured as cloud computing in which a plurality of devices share and cooperatively process one function via a network.

In addition, each step described in the above flowchart can be executed by one device or executed in a shared manner by a plurality of devices.

Further, in a case where a plurality of kinds of processing are included in a single step, the plurality of kinds of processing included in the single step may be executed by one device or by a plurality of devices in a shared manner.

### Combination Examples of Configurations

The present technology can be configured as follows.
(1)

An image processing device including:
a degradation conversion unit that performs degradation processing including mutually different degradation processes on a second image different from an input first image to generate a plurality of degraded images;
a comparison unit that compares the first image with each of the plurality of degraded images; and
a selection unit that selects, based on a result of comparison by the comparison unit, a parameter to improve an image quality of the first image from among parameters associated with the degradation processes of the plurality of degraded images.
(2)

The image processing device according to (1), wherein the parameters are acquired through learning using teacher images serving as a learning teacher and student images serving as a learning student, the student images being acquired by performing, on the teacher images, the degradation processing including the degradation processes associated with the respective parameters.
(3)

The image processing device according to (1) or (2), wherein
the comparison unit calculates a similarity between the first image and each of the plurality of degraded images, and
the selection unit selects the parameter to improve the image quality of the first image according to the similarity.
(4)

The image processing device according to (3), wherein the selection unit selects the parameter associated with the degradation process of the degraded image with a highest similarity to the first image as an applicable parameter used to improve the image quality of the first image.
(5)

The image processing device according to any one of (1) to (4), wherein the second image is an image acquired based on at least one of a subject and a composition of the first image.
(6)

The image processing device according to (5), wherein the second image is an image with a subject and a composition similar to the subject and the composition of the first image.
(7)

The image processing device according to any one of (1) to (6), wherein the second image is an image with a higher quality than the first image.
(8)

The image processing device according to (3), wherein the selection unit generates an applicable parameter used to improve the image quality of the first image by mixing the plurality of selected parameters.
(9)

The image processing device according to (8), wherein the selection unit selects a plurality of parameters associated with the degradation processes of a predetermined number of top degraded images with a highest similarity to the first image from among the plurality of degraded images.
(10)

The image processing device according to (9), wherein the selection unit mixes the plurality of parameters at a mixing ratio according to the similarities between the first image and the predetermined number of degraded images.
(11)

The image processing device according to (10), wherein the selection unit selects the plurality of parameters to be mixed from among the parameters associated with specific types of the degradation processes.
(12)

The image processing device according to (11), wherein the selection unit selects the specific types of the degradation processes based on an average value of the similarities calculated for each type of degradation process in a category in which the parameters associated with the degradation processes of different types are not allowed for mixing.
(13)

The image processing device according to any one of (9) to (12), wherein the selection unit selects the plurality of parameters when the highest similarity is less than a predetermined threshold value.
(14)

The image processing device according to (12), wherein the category of the degradation process is classified based on at least one of imaging conditions and encoding conditions.
(15)

The image processing device according to (14), wherein the imaging conditions include at least one of an original size, an ISO sensitivity, and a frame rate of an image.
(16)

The image processing device according to (14) or (15), wherein the encoding conditions include at least one of an encoding method and a quality.
(17)

The image processing device according to any one of (1) to (16), further including an image quality improvement processing unit that performs image quality improvement signal processing on the first image using the parameter selected by the selection unit.
(18)

An image processing method including: by an image processing device, performing degradation processing including mutually different degradation processes on a second image different from an input first image to generate a plurality of degraded images;
comparing the first image with each of the plurality of degraded images; and selecting, based on a result of comparison between the first image and each of the plurality of degraded images, a parameter to improve an image quality of the first image from among parameters associated with the degradation processes of the plurality of degraded images.
(19)

A computer-readable recording medium recording a program for executing processing of:
performing degradation processing including mutually different degradation processes on a second image different from an input first image to generate a plurality of degraded images;
comparing the first image with each of the plurality of degraded images; and
selecting, based on a result of comparison between the first image and each of the plurality of degraded images, a parameter to improve an image quality of the first image from among parameters associated with the degradation processes of the plurality of degraded images.

### Reference Signs List

11 Imaging processing device
21 Acquisition unit
22 Composition and subject estimation unit
23 High-quality image database
24 Degradation conversion unit
25 Storage unit
26 Similarity determination unit
27 Selection unit
28 Image quality improvement processing unit
101 Mixing unit

1. An image processing device comprising:
a degradation conversion unit that performs degradation processing including mutually different degradation processes on a second image different from an input first image to generate a plurality of degraded images;
a comparison unit that compares the first image with each of the plurality of degraded images; and
a selection unit that selects, based on a result of comparison by the comparison unit, a parameter to improve an image quality of the first image from among parameters associated with the degradation processes of the plurality of degraded images.

2. The image processing device according to claim 1, wherein the parameters are acquired through learning using teacher images serving as a learning teacher and student images serving as a learning student, the student images being acquired by performing, on the teacher images, the degradation processing including the degradation processes associated with the respective parameters.

3. The image processing device according to claim 1, wherein
the comparison unit calculates a similarity between the first image and each of the plurality of degraded images, and
the selection unit selects the parameter to improve the image quality of the first image according to the similarity.

4. The image processing device according to claim 3, wherein the selection unit selects the parameter associated with the degradation process of the degraded image with a highest similarity to the first image as an applicable parameter used to improve the image quality of the first image.

5. The image processing device according to claim 1, wherein the second image is an image acquired based on at least one of a subject and a composition of the first image.

6. The image processing device according to claim 5, wherein the second image is an image with a subject and a composition similar to the subject and the composition of the first image.

7. The image processing device according to claim 1, wherein the second image is an image with a higher quality than the first image.

8. The image processing device according to claim 3, wherein the selection unit generates an applicable parameter used to improve the image quality of the first image by mixing a plurality of the selected parameters.

9. The image processing device according to claim 8, wherein the selection unit selects a plurality of parameters associated with the degradation processes of a predetermined number of top degraded images with a highest similarity to the first image from among the plurality of degraded images.

10. The image processing device according to claim 9, wherein the selection unit mixes the plurality of parameters at a mixing ratio according to the similarities between the first image and the predetermined number of degraded images.

11. The image processing device according to claim 10, wherein the selection unit selects the plurality of parameters to be mixed from among the parameters associated with specific types of the degradation processes.

12. The image processing device according to claim 11, wherein the selection unit selects the specific types of the degradation processes based on an average value of the similarities calculated for each type of degradation process in a category in which the parameters associated with the degradation processes of different types are not allowed for mixing.

13. The image processing device according to claim 9, wherein the selection unit selects the plurality of parameters when the highest similarity is less than a predetermined threshold value.

14. The image processing device according to claim 12, wherein the category of the degradation process is classified based on at least one of imaging conditions and encoding conditions.

15. The image processing device according to claim 14, wherein the imaging conditions include at least one of an original size, an ISO sensitivity, and a frame rate of an image.

16. The image processing device according to claim 14, wherein the encoding conditions include at least one of an encoding method and a quality.

17. The image processing device according to claim 1, further comprising an image quality improvement processing unit that performs image quality improvement signal processing on the first image using the parameter selected by the selection unit.

18. An image processing method comprising: by an image processing device, performing degradation processing including mutually different degradation processes on a second image different from an input first image to generate a plurality of degraded images;
comparing the first image with each of the plurality of degraded images; and
selecting, based on a result of comparison between the first image and each of the plurality of degraded images, a parameter to improve an image quality of the first image from among parameters associated with the degradation processes of the plurality of degraded images.

19. A computer-readable recording medium recording a program for executing processing of:
performing degradation processing including mutually different degradation processes on a second image different from an input first image to generate a plurality of degraded images;
comparing the first image with each of the plurality of degraded images; and
selecting, based on a result of comparison between the first image and each of the plurality of degraded images, a parameter to improve an image quality of the first image from among parameters associated with the degradation processes of the plurality of degraded images.
